(19) United States
(12) Patent Application Publication
(10) Pub. No.: US 2022/0119299 A1
(43) Pub. Date: Apr. 21, 2022

(54) METHOD OF FABRICATING OPTICAL FIBER GLASS BASE MATERIAL, AND APPARATUS FOR FABRICATING OPTICAL FIBER GLASS BASE MATERIAL

(71) Applicant: Shin-Etsu Chemical Co., Ltd., Tokyo (JP)

(72) Inventor: Yusuke KASHIWAGI, Ibaraki (JP)

(21) Appl. No.: 17/450,561

(22) Filed: Oct. 12, 2021

(30) Foreign Application Priority Data
Oct. 15, 2020 (JP) 2020-174010
Sep. 14, 2021 (JP) 2021-149134

(51) Int. Cl. C03B 37/027; C03B 37/029

(52) U.S. Cl. CPC C03B 37/02718; C03B 2205/62; C03B 2201/02; C03B 37/029

(57) ABSTRACT

Provided is a method of fabricating an optical fiber glass base material, the method including a first step for dehydrating an optical fiber porous base material while causing a gas that includes at least a halogen or argon to distribute within a quartz core tube that accommodates the optical fiber porous base material; a second step for, after the first step, at least partially ventilating within the quartz core tube by causing a gas having helium as a main component to distribute within the quartz core tube; and a third step for, after the second step, transparently vitrifying the optical fiber porous base material while causing the gas having helium as a main component to distribute within the quartz core tube.

The contents of the following Japanese patent application(s) are incorporated herein by reference:
NO. 2020-174010 filed in JP on Oct. 15, 2020
NO. 2021-149134 filed in JP on Sep. 14, 2021

### BACKGROUND

### 1. Technical Field

The present invention relates to a method of fabricating an optical fiber glass base material, and an apparatus for fabricating an optical fiber glass base material.

### 2. Related Art

Patent Document 1 sets forth “A method of fabricating an optical fiber base material . . . includes a dehydration step, in which a porous glass base material 1, 1A (porous soot body) is subjected to dehydration treatment by supplying a dehydrant that includes an inert gas into a core tube 11, 11A, and a sintering step, in which the porous glass base material 1, 1A which has been subject to dehydration treatment is sintered” (paragraph [0022]), and “using argon gas as an inert gas mixed with the dehydrant, before raising the temperature of the porous glass base material 1, 1A in the dehydration step, cause a gas having a higher thermal conductivity than that of argon gas (hereinafter, this is abbreviated as a “high thermal conductivity gas”) to remain within the porous glass base material 1, 1A″ (paragraph [0024]).

### RELATED ART DOCUMENTS

[Patent Document]
[Patent Document 1] Japanese Patent No. 5298186

### BRIEF DESCRIPTION OF THE DRAWINGS

FIG. 1 is a view illustrating an outline of a sintering apparatus used in a first embodiment of the present invention; and

FIG. 2 is a view illustrating an outline of a sintering apparatus used in a second embodiment of the present invention.

### DESCRIPTION OF EXEMPLARY EMBODIMENTS

The present invention is described below through embodiments of the invention, but the following embodiments do not limit the invention according to the claims. In addition, there is no limitation to all combinations of features described in the embodiments being essential to a means for solving the invention.

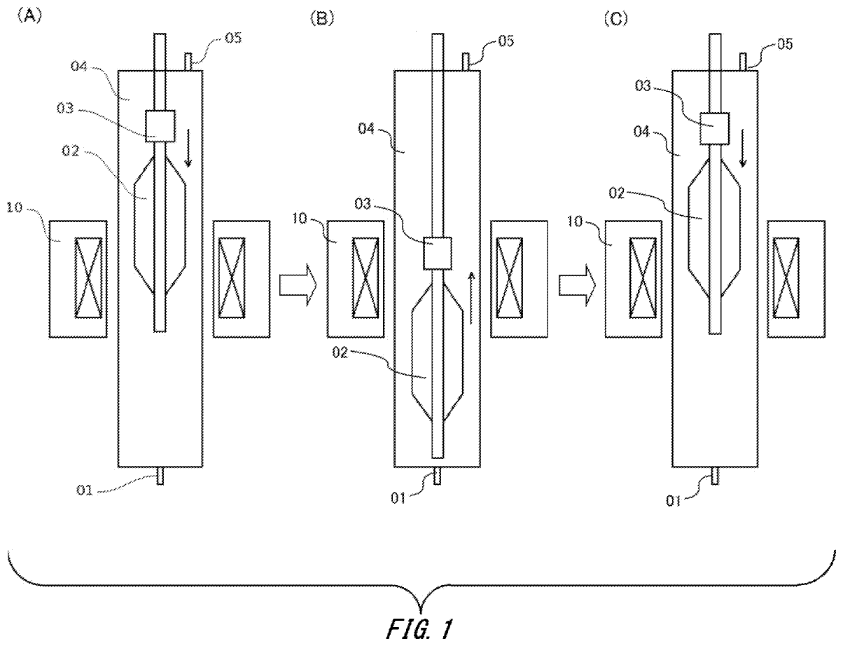

FIG. 1 is a view that illustrates an outline of a sintering apparatus used in a first embodiment in the present invention. (A) indicates a situation of an example of a first step, in which dehydration is performed while causing movement downward from an upper portion. (B) indicates a situation of an example of a second step which is subsequent to the step in (A) and in which internal gas is ventilated. Note that, at the same time as when the second step is started, an optical fiber porous base material (hereinafter may be simply referred to as a porous base material) 02 is raised to a position necessary for when a third step is started. (C) indicates a situation of an example of a third step which is subsequent to the step in (B) and in which the porous base material 02 is transparently vitrified while causing the porous base material 02 to move downward.

A sintering apparatus according to a first embodiment is an apparatus for fabricating an optical fiber base material, and is provided with a quartz core tube 04 and a heating apparatus 10. The quartz core tube 04 has a volume V1 that can accommodate the porous base material 02. The heating apparatus 10 is disposed around the quartz core tube 04.

The sintering apparatus may be further provided with a movement mechanism for causing the porous base material 02, which is inserted from an opening at one end of the quartz core tube 04, to move along the longitudinal direction of the quartz core tube 04. By a shaft 03 connected to the movement mechanism, the porous base material 02 is inserted along the longitudinal direction of the quartz core tube 04 from the opening at the upper portion of the quartz core tube 04.

The sintering apparatus performs the first step to thereby dehydrate the porous base material 02 by the heating apparatus 10 while causing gas that includes at least a halogen or argon to distribute within the quartz core tube 04 that accommodates the porous base material 02. The first step may dehydrate the porous base material 02 while causing the porous base material 02 to move within the quartz core tube 04, along the extension direction of the porous base material 02. The first step may dehydrate the porous base material 02 by raising the temperature inside the quartz core tube 04 to 1000-1300° C.

As a specific example, the first step is started after the porous base material 02 is inserted into the quartz core tube 04 and after the opening at the upper portion of the quartz core tube 04 is closed. At the same time as the first step is started, the sintering apparatus makes a pure halogen gas or a gas mixture that includes a noble gas and a halogen gas flow from a gas inlet port 01 into the quartz core tube 04. In order to keep the pressure inside the quartz core tube 04 constant, the sintering apparatus also discharges a certain amount of gas per unit time from a gas discharging port 05. From the first step through the third step, in order to keep the pressure inside the quartz core tube 04 constant, the sintering apparatus continues to discharge a certain amount of gas per unit time from the gas discharging port 05.

At the same time as starting the first step, the sintering apparatus also starts raising the temperature in accordance with the heating apparatus 10, and heats the quartz core tube 04. At this point, making the temperature inside the quartz core tube 04 be 1100-1300° C. is desirable to dehydrate the porous base material 02. In the first step, by the movement mechanism described above, the porous base material 02 is caused to move downward from the upper portion of the quartz core tube 04.

The pure halogen gas described above is an example of a gas having a halogen as a main component. In addition, the pure halogen gas and the gas mixture that includes a noble gas and a halogen gas are each an example of a gas that includes at least a halogen or argon.

In addition, a gas having a halogen as a main component may be a gas that includes at least one of chlorine and fluorine as a main component. A gas that includes at least one of chlorine and fluorine as a main component is desirable in dehydration treatment. In addition, a gas mixture of noble gas and halogen gas may be a gas mixture that includes at least one of chlorine gas and fluorine gas, and at least one of helium gas and argon gas.

In the first step, from among the total flow rate of gas caused to distribute within the quartz core tube 04, a flow rate U1 for the noble gas and a flow rate U2 for halogen satisfy the following [Formula 2].

0.2≤U2/(U1+U2)≤1.0 [Formula 2]

In other words, for the sintering apparatus, in the first step, it is assumed that 20-100% of the total amount of gas caused to flow into the quartz core tube 04 is halogen.

As described above, in the first step, the sintering apparatus causes a gas that includes at least a halogen or argon to distribute within the quartz core tube 04. In other words, the sintering apparatus does not cause only pure helium gas to distribute within the quartz core tube 04 in the first step. As a result, in comparison to a case of using only pure helium gas, the sintering apparatus, in the first step, can reduce the usage amount of helium gas which is more expensive than a gas that includes another element, and can reduce the cost of fabricating the optical fiber base material.

In the first step, in a case of causing a gas that includes at least a halogen or argon, for example argon gas, halogen gas, or a gas mixture that includes helium gas and these gases to distribute within the quartz core tube 04, these gases remain within the porous base material when the first step ends. These elements have low thermal conductivity in comparison to helium.

Here, as a transparent vitrification step which is performed after the dehydration step, in order to promote transparent vitrification, causing the porous base material to be transparently vitrified while causing a gas having helium, which has higher thermal conductivity than other elements, as a main component to distribute within a quartz core tube is known. However, in a case where transparent vitrification is started in a state where a gas that includes an element with a relatively low thermal conductivity remains within the porous base material, a region of the porous base material that is transparently vitrified at the beginning of the transparent vitrification step is more likely to become opaque due to the gas remaining. This is because helium gas does not sufficiently distribute near this region in the duration from when the transparent vitrification step is started and until this region is vitrified.

In contrast to this, the sintering apparatus accordingly to the present embodiment performs the second step after the first step described above to thereby cause a gas having helium as a main component to distribute within the quartz core tube 04 and at least partially ventilate within the quartz core tube 04. The gas having helium gas as a main component may be pure helium gas. In addition, the second step may at least partially ventilate within the quartz core tube 04 while raising the porous base material 02 which was moved downward in the first step.

In addition, in the second step, an integrated flow rate V2 of the gas having helium as the main component which is caused to distribute within the quartz core tube 04 may satisfy the following [Formula 1] with respect to the volume V1 of the quartz core tube 04.

V2≥0.5×V1 [Formula 1]

In other words, in the second step, the sintering apparatus may switch half or more of a fluid which is filled within the quartz core tube 04 at the time when the first step ends with a gas having helium as the main component.

As a specific example, the second step is started after the first step completes. At the same time as starting the second step, the sintering apparatus supplies pure helium gas into the quartz core tube 04 from the gas inlet port 01, and performs gas ventilation inside the quartz core tube 04. At the same time as starting the second step, the sintering apparatus also raises, by the movement mechanism, the porous base material 02 to a position necessary for the time when the subsequent third step is started. After raising the porous base material 02 to this position, the sintering apparatus may stop the movement mechanism for a certain amount of time, or may start the third step directly after this raising and start causing the porous base material 02 to move by the movement mechanism.

In a duration from the start of the second step and until the third step starts, the sintering apparatus makes the integrated flow rate V2, that is, the total volume V2, of pure helium gas caused to flow into the quartz core tube 04 to be 0.5 times or more the internal volume V1 of the quartz core tube 04, as indicated by the abovementioned [Formula 1]. This is desirable in order to make a region of the porous base material 02, which is vitrified at the initial period after the start of the third step, be transparent.

After the second step, the sintering apparatus also performs the third step to thereby transparently vitrify the porous base material 02 by the heating apparatus 10 while causing gas having helium as a main component to distribute within the quartz core tube 04. The third step may transparently vitrify the porous base material 02 by further raising the temperature inside the quartz core tube 04, for which the temperature was raised in the first step, to 1400-1650° C.

The third step may also gradually transparently vitrify the porous base material 02 from the downward end thereof by heating the porous base material 02 while causing the porous base material 02 to move downward within the quartz core tube 04, along the extension direction of the porous base material 02. As described above, as an example, in the second step, within the quartz core tube 04 is at least partially ventilated while raising the porous base material 02 moved downward in the first step to a position necessary when the third sintering step is started. In this manner, by raising the porous base material 02, which was caused to move downward in the first step, to this position in the second step, in the third step which is subsequent to the second step, it is possible to gradually transparently vitrify the porous base material 02 from the downward end thereof by starting downward movement of the porous base material 02 along the extension direction of the porous base material 02.

As a specific example, the sintering apparatus starts temperature-raising by the heating apparatus 10 at the same time as when the third step is started. Making the temperature inside the quartz core tube 04 in the third step be 1400-1650° C. is desirable for transparently vitrifying the porous base material 02. In the third step, using pure helium gas is desirable for transparent vitrification of the entire length of the porous base material 02.

In the third step, the sintering apparatus causes gradual transparent vitrification to gradually progress from the vertically downward end of the porous base material 02 by, in accordance with the movement mechanism, causing the porous base material 02 to move downward in the quartz core tube 04 from the position for when the third step is started. Note that, in the third step, it is desirable for the sintering apparatus to start downward movement of the porous base material 02 along the extension direction of the porous base material 02 after the temperature inside the quartz core tube 04 has reached 1400-1650° C.

In this manner, by virtue of the sintering apparatus according to the present embodiment, before starting a transparent vitrification step for the porous base material 02, for example before raising the temperature inside the quartz core tube 04 to approximately 1400-1650° C., a gas having pure helium as a main component is caused to distribute within the quartz core tube 04, and within the quartz core tube 04 is at least partially ventilated. By at least partially ventilating within the quartz core tube 04 with this gas, the sintering apparatus can, before starting the transparent vitrification step, facilitate removal of gas which has low thermal conductivity and which remains in the porous base material 02. As a result thereof, the sintering apparatus, in the transparent vitrification step, can prevent a region of the porous base material 02, which is to be transparently vitrified at the beginning of the transparent vitrification step, from become opaque. Accordingly, by virtue of the sintering apparatus, it is possible to obtain an optical fiber glass base material that has been sufficiently transparently vitrified.

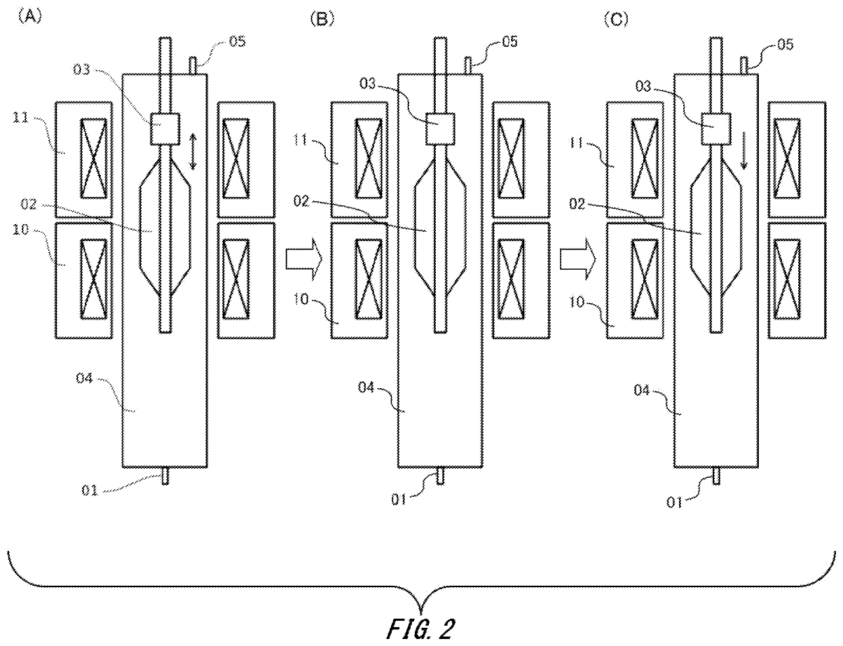

FIG. 2 is a view that illustrates an outline of a sintering apparatus used in a second embodiment in the present invention. (A) indicates a situation of an example of a first step, in which dehydration treatment is performed while causing the porous base material 02 to move up and down. (B) indicates a situation of an example of a second step which is subsequent to the step in (A) and in which internal gas is ventilated. (C) indicates a situation of an example of a third step which is subsequent to the step in (B) and in which the porous base material 02 is transparently vitrified while causing the porous base material 02 to move downward.

In the sintering apparatus according to the second embodiment, which has a configuration differing to that of the sintering apparatus according to the first embodiment, a heating apparatus 10 and a heating apparatus 11 are disposed around the quartz core tube 04. The other configurations of the sintering apparatus according to the second embodiment is similar to the configurations of the sintering apparatus according to the first embodiment, and thus the same reference numbers are applied to corresponding configurations, and duplicate descriptions are omitted.

The first step performed in the sintering apparatus according to the second embodiment is dehydrating the porous base material 02 by heating over the entirety of the porous base material 02. The first step may heat over the entirety of the porous base material 02 by using a plurality of heating apparatuses, for example the heating apparatus 10 and the heating apparatus 11, which are disposed lined up along the extension direction of the porous base material 02 around the quartz core tube 04. In this case, the third step may transparently vitrify the porous base material 02 by further raising the temperature inside the quartz core tube 04, for which the temperature was raised by the first step, by using one or more of the plurality of heating apparatuses, for example only the heating apparatus 10.

As a specific example, the sintering apparatus according to the second embodiment starts temperature-raising by the heating apparatus 10 and the heating apparatus 11 at the same time as the first step is started, and heats the quartz core tube 04. At this point, making the temperature inside the quartz core tube 04 be 1100-1300° C. is desirable to dehydrate the porous base material 02. By using the plurality of heating apparatuses 10 and 11 in this manner, it is possible to shorten the amount of time until the temperature inside the quartz core tube 04 is raised to this temperature range. In the first step, the porous base material 02 may be caused to move, by the movement mechanism, toward the lower portion from the upper portion of quartz core tube 04 or toward the upper portion from the lower portion of the quartz core tube 04. Other treatment details in the first step are similar to those in the first step according to the first embodiment, and thus duplicate description is omitted. The same applies in the subsequent second step and third step.

At the same time as starting the second step, the sintering apparatus may start raising the porous base material 02 to the position necessary for when the third step is started, and, at this time, may stop heating of the quartz core tube 04 by the heating apparatus 11. In this case, during the first step to the second step, the sintering apparatus may maintain heating of the quartz core tube 04 by the heating apparatus 10 to maintain the temperature inside the quartz core tube 04.

The sintering apparatus starts temperature-raising by the heating apparatus 10 at the same time as when the third step is started. At this time, the sintering apparatus may stop heating the quartz core tube 04 by the heating apparatus 11 throughout the third step.

Note that, as illustrated in FIG. 2, in the second embodiment, description was given for an example in which the heating apparatus 11 is disposed directly above the heating apparatus 10, but even if the heating apparatus 11 is disposed directly below the heating apparatus 10, the effect of the invention would not be impaired. In addition, a plurality of heating apparatuses may be installed directly above the heating apparatus 10, or a plurality of heating apparatuses may be installed directly below the heating apparatus 10.

By giving examples and comparative examples, description is given below in further detail regarding a method of fabricating the optical fiber base material according to the present embodiment, but the present invention is not limited to these, and various aspects are possible.

### Comparative Example 1

In a first step, the component ratio of a gas caused to distribute within a quartz core tube was 50% argon+50% chlorine, the quartz core tube was heated so that the temperature inside became 1000-1300° C., and dehydration was performed while causing an optical fiber porous base material to move downward from an upper portion in the quartz core tube.

In a second step, the temperature inside the quartz core tube was maintained at 1000-1300° C., and ventilation of internal gas was performed by causing gas with the same component ratio as the gas caused to distribute in the first step to distribute within the quartz core tube. The total volume of the gas caused to distribute within the quartz core tube was made to be equivalent to 60% of the internal volume of the quartz core tube. Note that, at the same time the second step was started, the porous base material was raised to a position necessary at the time the third step was started.

In the third step, while causing pure helium gas made up of 100% helium to distribute within the quartz core tube, the temperature inside the quartz core tube was raised to 1400-1650° C., the porous base material was caused to move gradually downward, and transparent vitrification was performed from the vertically downward end of the porous base material.

As a result, it was confirmed that there was an opaque portion in a region of the porous base material that was to be transparently vitrified at the beginning of the transparent vitrification step, in other words the vertically downward end of the porous base material.

### Comparative Example 2

In a first step, the component ratio of a gas caused to distribute within a quartz core tube was 50% argon+50% chlorine, the quartz core tube was heated so that the temperature inside became 1000-1300° C., and dehydration was performed while causing a porous base material to move downward from an upper portion in the quartz core tube.

In a second step, the temperature inside the quartz core tube was maintained at 1000-1300° C., and ventilation of internal gas was performed by causing pure helium gas made up of 100% helium to distribute within the quartz core tube. The total volume of the pure helium gas caused to distribute within the quartz core tube was made to be equivalent to 40% of the internal volume of the quartz core tube. Note that, at the same time the second step was started, the porous base material was raised to a position necessary at the time the third step was started.

In the third step, while causing pure helium gas made up of 100% helium to distribute within the quartz core tube, the temperature inside the quartz core tube was raised to 1400-1650° C., the porous base material was caused to move gradually downward, and transparent vitrification was performed from the vertically downward end of the porous base material.

As a result, it was confirmed that there was an opaque portion in a region of the porous base material that was to be transparently vitrified at the beginning of the transparent vitrification step, in other words the vertically downward end of the porous base material.

### Comparative Example 3

In a first step, the component ratio of a gas caused to distribute within a quartz core tube was 50% argon+50% chlorine, the quartz core tube was heated so that the temperature inside became 1000-1300° C., and dehydration was performed while causing a porous base material to move downward from an upper portion in the quartz core tube.

In a second step, the temperature inside the quartz core tube was maintained at 1000-1300° C., and ventilation of internal gas was performed by causing pure helium gas made up of 100% helium to distribute within the quartz core tube. The total volume of the pure helium gas caused to distribute within the quartz core tube was made to be equivalent to 45% of the internal volume of the quartz core tube. Note that, at the same time the second step was started, the porous base material was raised to a position necessary at the time the third step was started.

In the third step, while causing pure helium gas made up of 100% helium to distribute within the quartz core tube, the temperature inside the quartz core tube was raised to 1400-1650° C., the porous base material was caused to move gradually downward, and transparent vitrification was performed from the vertically downward end of the porous base material.

As a result, it was confirmed that there was an opaque portion in a region of the porous base material that was to be transparently vitrified at the beginning of the transparent vitrification step, in other words the vertically downward end of the porous base material.

### Example 1

In a first step, the component ratio of a gas caused to distribute within a quartz core tube was 50% argon+50% chlorine, the quartz core tube was heated so that the temperature inside became 1000-1300° C., and dehydration was performed while causing an optical fiber porous base material to move downward from an upper portion in the quartz core tube.

In a second step, the temperature inside the quartz core tube was maintained at 1000-1300° C., and ventilation of internal gas was performed by causing pure helium gas made up of 100% helium to distribute within the quartz core tube. The total volume of the pure helium gas caused to distribute within the quartz core tube was made to be equivalent to 60% of the internal volume of the quartz core tube. Note that, at the same time the second step was started, the porous base material was raised to a position necessary at the time the third step was started.

In the third step, while causing pure helium gas made up of 100% helium to distribute within the quartz core tube, the temperature inside the quartz core tube was raised to 1400-1650° C., the porous base material was caused to move gradually downward, and transparent vitrification was performed from the vertically downward end of the porous base material.

As a result, it was confirmed that a region of the porous base material which was to be transparently vitrified at the beginning of the transparent vitrification step, in other words the vertically downward end of the porous base material, was also transparent.

### Example 2

In a first step, the component ratio of a gas caused to distribute within a quartz core tube was 100% chlorine, the quartz core tube was heated so that the temperature inside became 1000-1300° C., and dehydration was performed while causing an optical fiber porous base material to move downward from an upper portion in the quartz core tube.

In a second step, the temperature inside the quartz core tube was maintained at 1000-1300° C., and ventilation of internal gas was performed by causing pure helium gas made up of 100% helium to distribute within the quartz core tube. The total volume of the pure helium gas caused to distribute within the quartz core tube was made to be equivalent to 40% of the internal volume of the quartz core tube. Note that, at the same time the second step was started, the porous base material was raised to a position necessary at the time the third step was started.

In the third step, while causing pure helium gas made up of 100% helium to distribute within the quartz core tube, the temperature inside the quartz core tube was raised to 1400-1650° C., the porous base material was caused to move gradually downward, and transparent vitrification was performed from the vertically downward end of the porous base material.

As a result, it was confirmed that a region of the porous base material which was to be transparently vitrified at the beginning of the transparent vitrification step, in other words the vertically downward end of the porous base material, was also transparent.

### Example 3

In a first step, the component ratio of a gas caused to distribute within a quartz core tube was 75% helium+25% chlorine, the quartz core tube was heated so that the temperature inside became 1000-1300° C., and dehydration was performed while causing a porous base material to move downward from an upper portion in the quartz core tube.

In a second step, the temperature inside the quartz core tube was maintained at 1000-1300° C., and ventilation of internal gas was performed by causing pure helium gas made up of 100% helium to distribute within the quartz core tube. The total volume of the pure helium gas caused to distribute within the quartz core tube was made to be equivalent to 60% of the internal volume of the quartz core tube. Note that, at the same time the second step was started, the porous base material was raised to a position necessary at the time the third step was started.

In the third step, while causing pure helium gas made up of 100% helium to distribute within the quartz core tube, the temperature inside the quartz core tube was raised to 1400-1650° C., the porous base material was caused to move gradually downward, and transparent vitrification was performed from the vertically downward end of the porous base material.

As a result, it was confirmed that a region of the porous base material which was to be transparently vitrified at the beginning of the transparent vitrification step, in other words the vertically downward end of the porous base material, was also transparent.

### Example 4

In a first step, the component ratio of a gas caused to distribute within a quartz core tube was 50% argon+50% chlorine, the quartz core tube was heated so that the temperature inside became 1000-1300° C., and dehydration was performed while causing a porous base material to move downward from an upper portion in the quartz core tube.

In a second step, the temperature inside the quartz core tube was maintained at 1000-1300° C., and ventilation of internal gas was performed by causing pure helium gas made up of 100% helium to distribute within the quartz core tube. The total volume of the pure helium gas caused to distribute within the quartz core tube was made to be equivalent to 50% of the internal volume of the quartz core tube. Note that, at the same time the second step was started, the porous base material was raised to a position necessary at the time the third step was started.

In the third step, while causing pure helium gas made up of 100% helium to distribute within the quartz core tube, the temperature inside the quartz core tube was raised to 1400-1650° C., the porous base material was caused to move gradually downward, and transparent vitrification was performed from the vertically downward end of the porous base material.

As a result, it was confirmed that a region of the porous base material which was to be transparently vitrified at the beginning of the transparent vitrification step, in other words the vertically downward end of the porous base material, was also transparent.

Gas conditions and results of transparent vitrification for the above-described examples and comparative examples are summarized in Table 1.

TABLE 1

| | Comparative | Comparative | Comparative | Example | Example | Example | Example |
|---|---|---|---|---|---|---|---|
| | example 1 | example 2 | example 3 | 1 | 2 | 3 | 4 |
| Component | 50% | 50% | 50% | 50% | Chlorine | Helium | 50% |
| ratio of gas | Argon + | Argon + | Argon + | Argon + | 100% | 75% + | Argon + |
| in first step | 50% | 50% | 50% | 50% | | Chlorine | 50% |
| | Chlorine | Chlorine | Chlorine | Chlorine | | 25% | Chlorine |
| Component | 50% | 100% | 100% | 100% | 100% | 100% | 100% |
| ratio of gas | Argon + | Helium | Helium | Helium | Helium | Helium | Helium |
| in second step | 50% | | | | | | |
| | Chlorine | | | | | | |
| Ratio of total | 60% | 40% | 45% | 60% | 60% | 60% | 50% |
| volume of gas | | | | | | | |
| caused to | | | | | | | |
| distribute in | | | | | | | |
| second step with | | | | | | | |
| respect to | | | | | | | |
| internal volume | | | | | | | |
| of quartz core | | | | | | | |
| tube | | | | | | | |
| Component | 100% | 100% | 100% | 100% | 100% | 100% | 100% |
| ratio of gas | Helium | Helium | Helium | Helium | Helium | Helium | Helium |
| in third step | | | | | | | |
| Transparency | Opaque | Opaque | Opaque | Transparent | Transparent | Transparent | Transparent |
| (visual | | | | | | | |
| observation) of | | | | | | | |
| region to be | | | | | | | |
| transparently | | | | | | | |
| vitrified at | | | | | | | |
| beginning of | | | | | | | |
| transparent | | | | | | | |
| vitrification | | | | | | | |
| step | | | | | | | |

The following are found from the above table. The comparative example 1, as a result of ventilating by causing a gas mixture of 50% argon+50% chlorine to distribute within the quartz core tube in the second step, has an opaque portion in a region of the porous base material which is to be transparently vitrified at the beginning of the transparent vitrification step. Accordingly, from a comparison between comparative example 1 and examples 1-4, it was found that it is desirable for the components of the gas caused to distribute within the quartz core tube in the second step to be only pure helium.

In addition, comparative examples 2 and 3 had an opaque portion in a region of the porous base material to be transparently vitrified at the beginning of the transparent vitrification step, as a result of making the total volume V2 of pure helium gas caused to distribute within the quartz core tube be 40-45% which is less than 50% of the internal volume V1 of the quartz core tube. Accordingly, from a comparison between comparative examples 2 and 3 and examples 1-4, it was found that it is desirable for the total volume V2 of pure helium gas caused to distribute within the quartz core tube in the second step be greater than or equal to 0.5 times the internal volume V1 of the quartz core tube 04.

In this manner, the ventilation conditions in the second step are found to be very important in order to prevent a region which is heated at the beginning of the transparent vitrification step from becoming opaque.

While the embodiments of the present invention have been described, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

### EXPLANATION OF REFERENCES

01 Gas inlet port
02 Porous base material
03 Shaft connected to movement mechanism
04 Quartz core tube
05 Gas discharging port
10 Heating apparatus
11 Heating apparatus

What is claimed is:

1. A fabrication method for fabricating an optical fiber glass base material, the method comprising:
dehydrating an optical fiber porous base material while causing a gas that includes at least a halogen or argon to distribute within a quartz core tube that accommodates the optical fiber porous base material;
after the dehydrating, at least partially ventilating within the quartz core tube by causing a gas having helium as a main component to distribute within the quartz core tube; and
after the at least partially ventilating, transparently vitrifying the optical fiber porous base material while causing the gas having helium as a main component to distribute within the quartz core tube.

2. The fabrication method according to claim 1, wherein
in the at least partially ventilating, an integrated flow rate V2 of the gas having helium as a main component which is caused to distribute within the quartz core tube satisfies the following [Formula 1] with respect to the volume V1 of the quartz core tube.
V2≥0.5×V1 [Formula 1]

3. The fabrication method according to claim 1, wherein
the gas in the at least partially ventilating is pure helium gas.

4. The fabrication method according to claim 1, wherein
the gas that includes at least a halogen or argon in the dehydrating is a gas having a halogen as a main component or a gas mixture of noble gas and halogen gas.

5. The fabrication method according to claim 4, wherein
the gas having a halogen as a main component is a gas that includes at least one of chlorine and fluorine as a main component, and the gas mixture of noble gas and halogen gas is a gas mixture that includes at least one of chlorine gas and fluorine gas and at least one of helium gas and argon gas.

6. The fabrication method according to claim 4, wherein
in the dehydrating, from among a total flow rate of gas caused to distribute within the quartz core tube, a noble gas flow rate U1 and a halogen flow rate U2 satisfy the following [Formula 2].
0.2≤U2/(U1+U2)≤1.0 [Formula 2]

7. The fabrication method according to claim 1, wherein
in the dehydrating, the optical fiber porous base material is dehydrated while causing the optical fiber porous base material to move along an extension direction of the optical fiber porous base material within the quartz core tube.

8. The fabrication method according to claim 1, wherein
in the transparently vitrifying, the optical fiber porous base material is gradually transparently vitrified from a downward end of the optical fiber porous base material by heating the optical fiber porous base material while causing the optical fiber porous base material to move downward along an extension direction of the optical fiber porous base material within the quartz core tube.

9. The fabrication method according to claim 8, wherein
in the transparently vitrifying, downward movement of the optical fiber porous base material is started along the extension direction after the temperature inside the quartz core tube has reached 1400-1650° C.

10. The fabrication method according to claim 8, wherein
in the dehydrating, the optical fiber porous base material is dehydrated while causing the optical fiber porous base material to move downward along the extension direction within the quartz core tube, and
in the at least partially ventilating, within the quartz core tube is at least partially ventilated while raising the optical fiber porous base material which was moved downward in the dehydrating so that it is possible to gradually transparently vitrify the optical fiber porous base material from the downward end by starting downward movement of the optical fiber porous base material along the extension direction in the subsequent transparently vitrifying.

11. The fabrication method according to claim 1, wherein
in the dehydrating, the optical fiber porous base material is dehydrated by heating over the entirety of the optical fiber porous base material.

12. The fabrication method according to claim 11, wherein
in the dehydrating, heating is performed over the entirety of the optical fiber porous base material using a plurality of heating apparatuses disposed lined up along an extension direction of the optical fiber porous base material, around the quartz core tube.

13. The fabrication method according to claim 12, wherein
in the transparently vitrifying, the optical fiber porous base material is transparently vitrified by using one or more of the plurality of heating apparatuses to further raise the temperature inside the quartz core tube which was subject to temperature-raising in the dehydrating.

14. The fabrication method according to claim 13, wherein
in the dehydrating, the temperature inside the quartz core tube is raised to 1000-1300° C., and
in the transparently vitrifying, the temperature inside the quartz core tube which was subject to temperature-raising in the dehydrating is further raised to 1400-1650° C.

15. The fabrication method according to claim 1, wherein
in the dehydrating, the optical fiber porous base material is dehydrated by raising the temperature inside the quartz core tube to 1000-1300° C.

16. The fabrication method according to claim 1, wherein
in the transparently vitrifying, the optical fiber porous base material is transparently vitrified by raising the temperature inside the quartz core tube to 1400-1650° C.

17. An apparatus for fabricating an optical fiber base material, the apparatus comprising:
a quartz core tube having a volume V1 which can accommodate an optical fiber porous base material; and
a heating apparatus disposed around the quartz core tube,
wherein
dehydrating the optical fiber porous base material by the heating apparatus while a gas that includes at least a halogen or argon is caused to distribute within the quartz core tube which is accommodating the optical fiber porous base material,
after the dehydrating, at least partially ventilating within the quartz core tube by causing a gas having helium as a main component to distribute within the quartz core tube; and
after the at least partially ventilating, transparently vitrifying the optical fiber porous base material by the heating apparatus while causing the gas having helium as a main component to distribute within the quartz core tube
are performed.

18. The apparatus according to claim 17, further comprising:
a movement mechanism for causing the optical fiber porous base material, which is inserted from an opening at one end of the quartz core tube, to move along a longitudinal direction of the quartz core tube.

19. The apparatus according to claim 17, wherein
in the at least partially ventilating, an integrated flow rate V2 of the gas having helium as the main component which is caused to distribute within the quartz core tube satisfies the following [Formula 3] with respect to the volume V1 of the quartz core tube.
V2≥0.5×V1 [Formula 3]

20. The apparatus according to claim 17, wherein
the gas in the at least partially ventilating is pure helium gas.
